(19) United States
(12) Patent Application Publication
(10) Pub. No.: US 2013/0033166 A1
(43) Pub. Date: Feb. 7, 2013

(54) LIGHTING APPARATUS

(71) Applicants: Yoshiyuki Kitamura, Osaka-shi (JP); Hiroaki Nagata, Osaka-shi (JP)

(72) Inventors: Yoshiyuki Kitamura, Osaka-shi (JP); Hiroaki Nagata, Osaka-shi (JP)

(73) Assignee: SHARP KABUSHIKI KAISHA, Osaka-shi, Osaka (JP)

(21) Appl. No.: 13/642,300

(22) PCT Filed: Mar. 4, 2011
(86) PCT No.: PCT/JP2011/055062

§ 371 Date: Oct. 19, 2012

(30) Foreign Application Priority Data
Apr. 20, 2010 (JP) 2010-096994

(51) Int. Cl. H05B 33/02

(52) U.S. Cl. 313/46

(57) ABSTRACT

A lighting apparatus includes a light source module, a power supply circuit section supplying power to the light source module, a heat radiating section accommodating the power supply circuit section inside and radiating the heat generated in the power supply circuit section, a base connected to an external power supply, and an insulating ring provided between the heat radiating section and the base and making electrical insulation. With regard to the lighting apparatus, the insulating ring is a thermal conductor. Since the insulating ring functions as the thermal conductor, the heat generated in the power supply circuit section is transferred to the heat radiating section and the base via the insulating ring so that the heat is radiated to outside from the heat radiating section and the base.

This application is the national phase under 35 U.S.C. §371 of PCT International Application No. PCT/JP2011/055062 which has an International filing date of Mar. 4, 2011 and designated the United States of America.

### FIELD

The present invention relates to a lighting apparatus including a light source, a power supply circuit section supplying power to the light source, a heat radiating section accommodating the power supply circuit section inside and radiating heat generated in the power supply circuit section, a connecting section connected to an external power supply, and an insulator provided between the heat radiating section and the connecting section and making electrical insulation.

### BACKGROUND

A lighting apparatus generally accommodates inside heat-generating components such as a light source and a power supply circuit section supplying power to the light source. Unfortunately, the performance of a heat-generating component such as a light source like a light emitting diode (hereinafter referred to as the “LED”) and an electronic circuit component constituting a power supply circuit section cannot be ensured when the temperature of the heat-generating component increases due to the heat-generation thereof. Additionally, in view of the safety reason, it is undesirable that the temperature of the outer surface of the lighting apparatus increases. Therefore, it has been proposed that a lighting apparatus is able to radiate heat to the air outside of the lighting apparatus from the heat-generating component (for example, see Japanese Patent Application Laid-Open No. 2008-186776).

A lighting apparatus disclosed in Japanese Patent Application Laid-Open No. 2008-186776 includes a light source section 510 having a light source 511, a power supply section (power supply circuit section) 530 lighting the light source 511, a power terminal block 540 supplying power to the power supply section 530, and an apparatus main body 520 to which the light source section 510, the power supply section 530 and the power terminal block 540 are installed. The lighting apparatus is installed on ceiling by a supporting tool 550 composed of spring material and located at the outer periphery of the apparatus main body 520 such that the light source section 510 is close to an installation aperture. The lighting apparatus is used as a so-called downlight (see FIG. 5).

The apparatus main body 520 is made of aluminum die casting and configured as a cylindrical case member. The apparatus main body 520 also functions as a heat radiating section radiating heat generated in the light source 511 and the power supply section 530. The apparatus main body 520 includes a partition board 521 partitioning the inner part of the apparatus main body 520. The partitioning board 521 also functions as a supporting section arranging the light source section 510. The power supply section 530 is held by the apparatus main body 520 with having a predetermined spacing for ensuring an electrically insulation distance between a wiring substrate 531 of the power supply section 530 and the partition board 521 of the apparatus main body 520.

### SUMMARY

In the lighting apparatus related to Japanese Patent Application Laid-Open No. 2008-186776, the heat generated in the power supply section 530 is transferred to the apparatus main body 520 and radiated to outside from the apparatus main body 520.

However, the wiring substrate 531 of the power supply section 530 only comes in contact with the apparatus main body 520 at the periphery so that the heat transfer area for conducting the heat generated in the power supply section 530 cannot be fully ensured. Therefore, the heat generated in the power supply section 530 cannot be fully conducted to the apparatus main body 520 so that heat radiation cannot be fully performed.

The present invention has been made in view of such circumstances. It is an object to provide a lighting apparatus which can fully radiate the heat generated in the power supply circuit section.

A lighting apparatus related to the present invention includes a light source, a power supply circuit section supplying power to the light source, a heat radiating section accommodating the power supply circuit section inside and radiating heat generated in the power supply circuit section, a connecting section connected to an external power supply, and an insulator provided between the heat radiating section and the connecting section, and the insulator is a thermal conductor.

In the present invention, the insulator is provided between the heat radiating section radiating the heat generated in the power supply circuit section and the connecting section connected to the external power supply. Since the heat radiating section and the connecting section are connected thermally through the insulator as the heat thermal conductor, the heat generated in the power supply circuit section can be transferred to the heat radiating section and the connecting section via the insulator, and then the heat can be radiated to outside from the heat radiating section and the connecting section. The connecting section can also be used as a heat radiating member so that the heat from the power supply circuit section can be fully radiated.

The lighting apparatus related to the present invention features that the connecting section is formed integratedly with the insulator.

In the present invention, since the connecting section is formed integratedly with the insulator, the connecting section can be adhered to the insulator so that the heat transfer resistance between the connecting section and the insulator can be minimized. As a result, the heat can be efficiently transferred from the insulator to the connecting section. Therefore, the connecting section can also be used efficiently as the heat radiating member so that the heat from the power supply circuit section can further be fully radiated.

The lighting apparatus related to the present invention features that an adhesive layer is provided between the connecting section and the insulator.

In the present invention, since the adhesive layer is provided between the connecting section and the insulator, the connecting section can be adhered to the insulator. By using an adhesive agent made of material with high thermal conductivity, the heat transfer resistance between the connecting section and the insulator may be minimized. As a result, the heat can be efficiently transferred from the insulator to the connecting section so that the connecting section can be efficiently used as the heat radiating member. Therefore, the heat from the power supply circuit section can further be fully radiated.

The lighting apparatus related to the present invention features that the power supply circuit section includes a plurality of circuit components, and at least a part of the circuit components comes in contact with the insulator.

In the present invention, the power supply circuit section includes the plurality of circuit components, and since at least a part of the circuit components comes in contact with the insulator, the heat generated in the power supply circuit section can be easily transferred to the insulator. For example, by filling packing media made of material with high thermal conductivity between the power supply circuit section and the insulator, the heat generated in the power supply circuit section can be further transferred to the insulator efficiently. The heat generated in the power supply circuit section can be efficiently transferred to the heat radiating section and the connecting section via the insulator.

The lighting apparatus related to the present invention features that a thermal conduction layer is provided between the power supply circuit section and the insulator.

In the present invention, the thermal conduction layer is provided between the power supply circuit section and the insulator. The gas such as air is not interposed between the power supply circuit section and the insulator, therefore, the heat from the power supply circuit section can be efficiently transferred to the insulator. By using the material with high thermal conductivity as the thermal conducting layer, the heat from the power supply circuit section can be efficiently transferred to the heat radiating section and the connecting section via the insulator.

The lighting apparatus related to the present invention features that the insulator contains polyamide and/or liquid crystal polymer.

In the present invention, since the insulator is made of resin containing polyamide and/or liquid crystal polymer, the insulator can function as a good thermal conductor able to minimize heat transfer resistance inside the insulator while ensuring the insulation properties. Therefore, the heat generated in the power supply circuit can be efficiently transferred to the heat radiating section and the connecting section via the insulator. Moreover, since the insulator is made of resin, the connecting section is formed integratedly with the insulator easily by using an injection molding machine so that the manufacturing process can be simplified.

According to the present invention, the heat generated in the power supply circuit section can be fully radiated.

The above and further objects and features will more fully be apparent from the following detailed description with accompanying drawings.

### BRIEF DESCRIPTION OF THE DRAWINGS

FIG. 1 is a schematic outline view of a lighting apparatus related to an embodiment of the present invention.

FIG. 2 is a schematic vertical cross sectional view of the lighting apparatus related to the present embodiment.

FIG. 3 is a schematic horizontal cross sectional view related to the line III-III of FIG. 1.

FIG. 4 is a schematic vertical cross sectional view at the vicinity of a power supply circuit section of the lighting apparatus related to another embodiment of the present invention.

FIG. 5 is a schematic vertical cross sectional view of a lighting apparatus related to a prior art.

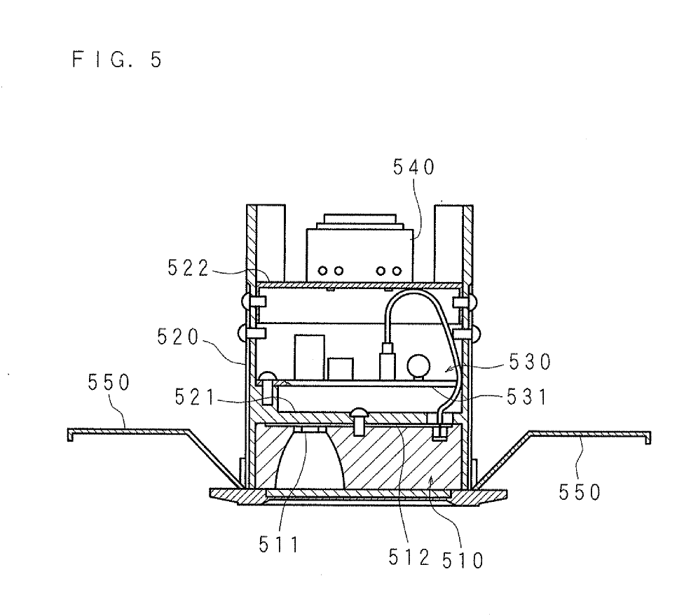

### DETAILED DESCRIPTION

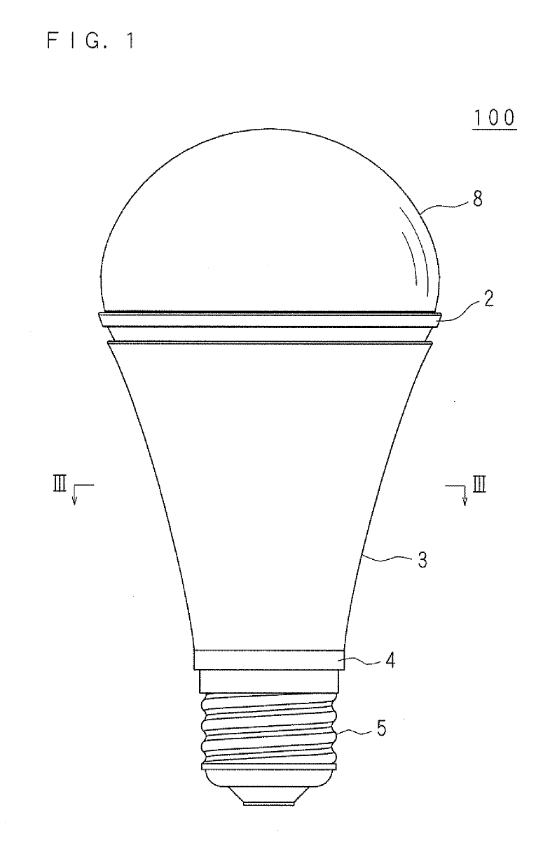

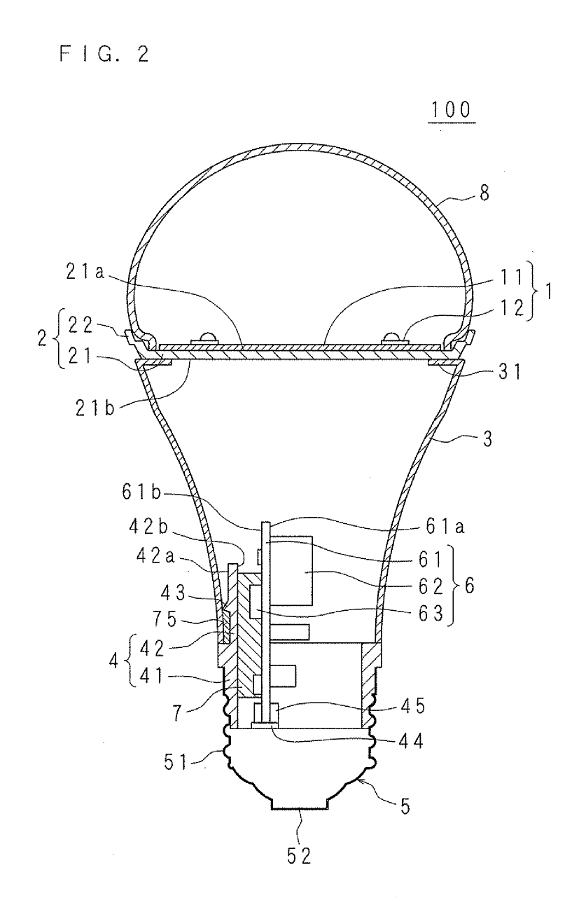

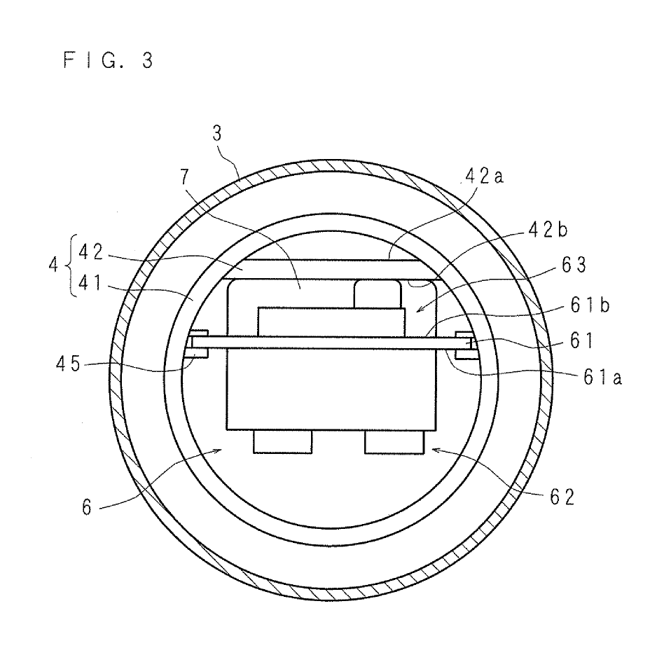

The present invention will be described below in detail as an example of a bulb-type lighting apparatus based on drawings illustrating embodiments of the present invention. FIG. 1 is a schematic outline view of a lighting apparatus related to an embodiment of the present invention. FIG. 2 is a schematic vertical cross sectional view of the lighting apparatus related to the present embodiment. FIG. 3 is a schematic horizontal cross sectional view related to the line III-III of FIG. 1.

Reference numeral 1 denoted in figures is a light source module as the light source. The light source module 1 includes a disc LED substrate 11 and a plurality of LEDs 12 mounted on one surface of the LED substrate 11. The LED substrate 11 also functions as the thermal conductor for conducting the heat from the LEDs 12 to a heat radiator plate 2 attached to the light source module 1. For example, the LED substrate 11 is made of metal such as iron or aluminum. The LED 12 is a surface mount type LED including, for example, LED elements, sealing resin sealing the LED elements, an input terminal, an output terminal and the like.

The LEDs 12 are mounted on one surface of the LED substrate 11. The LED substrate 11 is fixed to the heat radiator plate 2 at the other surface (the surface opposite to the surface mounted by the LEDs 12). The heat radiator plate 2 is made of metal such as aluminum and includes a disc light source holding section 21 and a flat peripheral wall section 22 vertically arranged on the outer periphery of the light source holding section 21. The LED substrate 11 is fixed to one surface 21a of the light source holding section 21 of the heat radiator plate 2. The peripheral wall section 22 is vertically arranged at the side of the one surface 21a of the light source holding section 21. The diameter of the peripheral wall section 22 gradually becomes larger toward the protrusion side from the side of the light source holding section 21. The heat radiator plate 2 to which the light source module 1 is attached is attached to the heat radiating section 3 such that the side of the other surface 21b of the light source holding section 21 is at the side of the heat radiating section 3.

The heat radiating section 3 is made of metal such as aluminum and formed into a cylindrical shape. The heat radiating section 3 has an external form of conical shape whose diameter gradually becomes larger from one end to the other end (the side at which the diameter is enlarged) in the longitudinal direction. At the inner side of the other end of the heat radiating section 3, a mounting seat 31 to which the heat radiator plate 2 is attached is disposed. The mounting seat 31, for example, is annularly provided on the periphery at the inner side of the heat radiating section 3. Moreover, the shape of the mounting seat 31 is not limited to this case. The mounting seat 31 can be formed into any shape for allowing the heat radiator plate 2 to be attached to the mounting seat 31.

In order that the threaded holes (not shown) provided on the LED substrate 11, the threaded holes (not shown) provided on the heat radiator plate 2 and the threaded holes provided on the mounting seat 31 of the heat radiating section 3 at the other end (the side at which the diameter is enlarged) are aligned each other, the light source module 1 and the heat radiator plate 2 are carried on the mounting seat 31 of the heat radiating section 3, and then the light source module 1 and the heat radiator plate 2 are fixed to the heat radiating section 3 by screwing the threaded screws into threaded holes.

The LED substrate 111 comes in contact with the heat radiator plate 2 at a substantially entire surface, and the heat radiator plate 2 comes in contact with the heat radiating section 3 at a substantially entire surface. Therefore, a sufficient heat transfer area is created. Accordingly, the heat from the LEDs 12 is efficiently conducted to the heat radiator plate 2 via the LED substrate 11, and then a part of the heat is radiated to the air outside of the lighting apparatus 100 from the periphery of the heat radiator plate 2. The remaining part of the heat is efficiently conducted to the heat radiating section 3 from the heat radiator plate 2, and then the heat is radiated to the air outside of the lighting apparatus 100 from the heat radiating section 3. Since heat is radiated through the heat radiator plate 2 and the heat radiating section 3, the LED 12 is cooled down to the necessary temperature for ensuring the predetermined performance as well as durability. Moreover, it is preferable that a thermal conduction sheet or grease with better thermal conductivity is interposed between the LED substrate 11 and the heat radiator plate 2 as well as between the heat radiator plate 2 and the heat radiating section 3. The heat radiator plate 2 and the heat radiating section 3 function as the radiator for radiating the heat from the light source module 1. Additionally, the heat radiator plate 2 and the heat radiating section 3 function as the housing body of the lighting apparatus.

A base 5 is provided as the connecting section at the one end of the heat radiating section 3 (the opposite side relative to the side where the mounting seat 31 is provided) via an insulating ring 4 as the insulator for making electrical insulation between the base 5 and the heat radiating section 3. The cylindrical insulating ring 4 includes a base holding section 41 holding the base 5 and a junction 42 provided at the base holding section 41 in a coupled manner and connected to the heat radiating section 3.

As shown in FIG. 3, the junction 42 is provided at the inner side of the base holding section 41. The junction 42 is a plate that is parallel to the plane passing through the center of the base holding section 41. At an outer surface 42a of the junction 42, an engaging blade 43 is provided for engaging with an engaging section (not shown) formed at the inner surface of the heat radiating section 3. At the end portion of the base holding section 41 located at the opposite side of the junction 42, a holding section 44 is provided for holding an after-mentioned power supply substrate of the power supply circuit section and is parallel to the junction 42 with an appropriate spacing. Moreover, at the base holding section 41, an engaging concavity 45 engaging to the power supply substrate is provided to be parallel to the junction 42 with an appropriate spacing.

In the present embodiment, the insulating ring 4 is made of resin with excellent heat radiating property and electrical insulating property, also known as heat radiation resin. The heat radiation resin has the electrical insulating property. The thermal conductivity of heat radiation resin is, for example, about 1 to 70 (W/m·K). The heat radiation resin is made of synthetic resin having, for example, polyamide (the so-called nylon) and/or liquid crystal polymer as the base. Additionally, the heat radiation resin having the electrical insulating property is preferable, however, it is not limited to utilize the synthetic resin containing polyamide and/or crystal liquid polymer.

Additionally, the insulating ring 4 may be made of material with excellent heat radiating property and electrical insulating property. The insulating ring 4 may also be made of ceramics. An electrical insulating material with high infrared emissivity (thermal emissivity with regard to the wavelength spectrum of infrared), for example, metallic oxide such as aluminum oxide and boron nitride as the ceramics material is applicable.

The base 5 is in bottomed cylindrical shape and includes one pole terminal 51 of which the cylindrical portion is performed by screw processing for screwing with a light bulb socket and the other pole terminal 52 protruded at the bottom of the base 5. The one pole terminal 51 is electrically isolated from the other pole terminal 52. The outer shape of cylindrical portion of the base 5 is formed as the same shape of, for example, an E17 or E26 screwed cap.

With regard to the present embodiment, the base 5 is formed integratedly with the insulating ring 4. With regard to this integrated formation, a metal mold corresponding to the shape of the insulating ring 4 is inserted into the base 5, and then the before-mentioned heat radiation resin in melted state is flowed into the metal mold by using an injecting molding machine, then the heat radiation resin is solidified. To cover the inner surface of the cylindrical portion of the base 5, the heat radiation resin is adhered to the inner surface. In this way, the base 5 is integratedly formed with the insulating ring 4, therefore, the base 5 can be adhered to the base holding section 41 of the insulating ring 4 without creating gap. As a result, the increase of thermal conduction resistance due to the existence of air can be suppressed so that the thermal conduction from the insulating ring 4 to the base 5 can be effectively performed.

The insulating ring 4 and the base 5 formed into an integrated body in such a way are attached to the heat radiating section 3 by engaging the engaging blade 43 provided at the junction 42 of the insulating ring 4 to the engaging section (not shown) formed at the inner surface of the heat radiating section 3. An adhesive agent 75 is filled between the heat radiating section 3 and the junction 42 of the insulating ring 4. It is preferable that the adhesive agent 75 is an adhesive agent with high thermal conductivity containing base material such as silicone. Since the adhesive agent 75 is filled between the heat radiating section 3 and the junction 42 of the insulating ring 4, the gas such as air does not exist so that the heat transfer resistance between the heat radiating section 3 and the insulating ring 4 can be minimized.

As the insulating ring 4 functions as the thermal conductor, the heat radiating section 3 is thermally connected to the base 5 and then the heat can be efficiently conducted from the insulating ring 4 to the heat radiating section 3 and the base 5. By filling the adhesive agent 75 with high thermal conductivity between the heat radiating section 3 and the junction 42 of the insulating ring 4, the heat can be further efficiently conducted from the insulating ring 4 to the heat radiating section 3. Additionally, the insulating ring 4 also functions as the insulator for making electrical insulation between the base 5 and the heat radiating section 3. Moreover, the insulating ring 4 also functions as the connecting body for making connection with the base 5 and the heat radiating section 3.

The power supply circuit section 6 for supplying power of predetermined voltage and current to the light source module 1 via a wire is accommodated in the cavity formed by the heat radiator plate 2, the heat radiating section 3 and the insulating ring 4.

The power supply circuit 6 includes a rectangular-plated power supply circuit substrate 61 and a plurality of circuit components mounted on the power supply circuit substrate 61. The circuit components including a diode bridge that performs a full-wave rectification of AC current supplied from an external AC power supply, a transformer that transforms a rectified power voltage to a predetermined voltage, a diode that is connected to both primary side and secondary side of the transformer, and an IC are distributed and mounted on both surfaces of the power supply substrate 61. For example, a glass epoxy substrate, paper phenol substrate or the like is used as the power supply substrate 61.

A plurality of circuit components 62 are mounted on one surface 61a of the power supply substrate 61 of the power supply circuit section 6. Circuit components 63 mounted on the other surface 61b of the power supply substrate 61 relatively produce more heat due to the supply current as compared with the circuit components 62 mounted on the one surface 61a.

The power supply circuit section 6 is held in the cavity formed through the heat radiation section 3 and the insulating ring 4 by engaging one part of the power supply substrate 61 to an engaging concavity 45 provided at the insulating ring 4 such that the side of the other surface 61b (the side on which the circuit components 63 are mounted) of the power supply substrate 61 is at the side of the junction 42 of the insulating ring 4. In the holding state, a part of the circuit components 63 comes in contact with an inner surface 42b of the junction 42 as shown in FIG. 3. Since a part of the circuit components 63 comes in contact with the insulating ring 4, a part of the heat generated in the power circuit section 6 can be directly transferred to the insulating ring 4. Therefore, the heat from the power supply circuit section 6 can efficiently be transferred to the insulating ring 4.

A resin 7 as the thermal conduction layer is filled between the other surface 61b of the power supply substrate 61 of the power supply circuit section 6 and the inner surface 42b of the junction 42 of the insulating ring 4, a part of the circuit components 63 comes in contact with the resin 7 as shown in FIG. 2. For example, the resin 7 is resin with high thermal conductivity such as silicone resin and polyurethane resin. The resin 7 is filled between the power supply circuit section 6 and the insulating ring 4, the heat from the power supply circuit section 6 can be efficiently transferred to the insulating ring 4 because the gas such as air does not exist between the power supply circuit section 6 and the insulating ring 4. The resin 7 with high thermal conductivity is filled so that the heat from the power supply circuit section 6 can be efficiently transferred to the heat radiating section 3 and the base 5 via the insulating ring 4.

The power supply circuit section 6 is electrically connected to the one pole terminal 51 and the other pole terminal 52 of the base 5 via a wire (not shown). Additionally, the power supply circuit section 6 is electrically connected through a connector to the light source module 1 via a wire (not shown). Moreover, a pin plug may also be used for making electrical connection without using a wire.

On the other hand, a light-permeable cover 8 is attached to the heat radiator plate 2 at the other end of the heat radiating section 3 for covering the side of the direction of light emission from the LEDs 12. The cover 8 is made of milky-white glass having a hemispherical shape. It is preferable that an anti-scattering film is provided over a substantially entire surface on the inner surface of the cover 8 for preventing the scattering at the occurrence of fracture of the cover 8. The periphery at the aperture side of the cover 8 is attached to the periphery of the light source holding section 21 of the heat radiator plate 2 through an adhesive agent. Moreover, the material of the cover 8 is not only limited to glass. For example, the cover 8 may be made of resin such as polycarbonate.

The lighting apparatus 100 configured as described above is connected to the external AC power supply by screwing the base 5 with a light bulb socket. In this state, as the power supply is on, AC current is supplied to the power supply circuit section 6 via the base 5. The power supply circuit section 6 supplies power of predetermined voltage and current to the light source module 1, and then the LEDs 12 are lighted up.

As the LEDs 12 are lighted up, the LEDs 12 and the power supply circuit section 6 mainly radiate heat. As described above, the heat from the LEDs 12 are conducted to the heat radiator plate 2 and the heat radiating section 3, and then the heat are radiated to the air outside the lighting apparatus 100 from the heat radiator plate 2 and the heat radiating section 3. On the other hand, the heat from the power supply circuit section 6 is conducted to the insulating ring 4 directly or via the resin 7. A part of the conducted heat is transferred to the heat radiating section 3, and then the heat is radiated to the air outside the lighting apparatus 100 from the heat radiating section 3. The other part of the heat conducted to the insulating ring 4 is transferred to the base 5, and then the heat is radiated to the air outside the lighting apparatus 100 from the base 5.

As described above, with regard to the lighting apparatus 100 related to the present embodiment, the insulating ring 4 provided between the heat radiating section 3 and the base 5 is the thermal conductor, therefore, the heat generated in the power supply circuit section 6 can be transferred to the heat radiating section 3 and the base 6 via the insulating ring 4 so that the heat can be radiated to outside from the heat radiating section 3 and the base 5. In this way, the base 5 can also be used as the heat radiating member, therefore, the heat radiating area can be enlarged so that the heat from the power supply circuit section 6 can be fully radiated.

The base 5 is formed integratedly with the insulating ring 4, therefore, the base 5 can be adhered to the insulating ring 4 without creating gap. Thus, heat transfer resistance between the base 5 and the insulating ring 4 can be reduced. As a result, since the heat can be efficiently transferred from the insulating ring 4 to the base 5, the base can be effectively used as the heat radiating member. Therefore, the heat from the power supply circuit section 6 can further be fully radiated.

Since the insulating ring 4 is made of resin containing polyamide and/or crystal polymer, the insulating ring 4 functions as the good thermal conductor able to reduce heat transfer resistance inside while ensuring the insulating property. Therefore, the heat generated in the power supply circuit section 6 can be efficiently transferred to the heat radiating section 3 and the base 5 via the insulating ring 4. Additionally, since the insulating ring 4 is made of resin, the base 5 can be integratedly formed with the insulating ring 4 easily by using an injection molding machine. Therefore, the manufacturing process can be simplified.

Since a part of the circuit components 63 of the power supply circuit section 6 comes in contact with the insulating ring 4, a part of the heat generated in the power supply circuit section 6 can be directly transferred to the insulating ring 4 without passing through other substances. As a result, the heat from the power supply circuit section 6 can be efficiently transferred to the insulating ring 4.

The resin 7 as the material with thermal conductivity is filled between the other surface 61b of the power supply substrate 61 of the power supply circuit section 6 and the inner surface 42b of the junction 42 of the insulating ring 4. The gas such as air does not exist between the power supply circuit section 6 and the insulating ring 4, therefore, the heat from the power supply circuit section 6 can be efficiently transferred to the insulating ring 4. The heat from the power supply circuit section 6 is efficiently transferred to the heat radiating section 3 and the base 5 via the insulating ring 4 by using the resin 7 with high thermal conductivity.

Since the resin 7 is filled in the gap between the nearby other surface 61b of the power supply substrate 61 of the power supply circuit section 6 and the inner surface 42b of the junction 42 of the insulating ring 4, the amount of the resin 7 to be filled can be reduced.

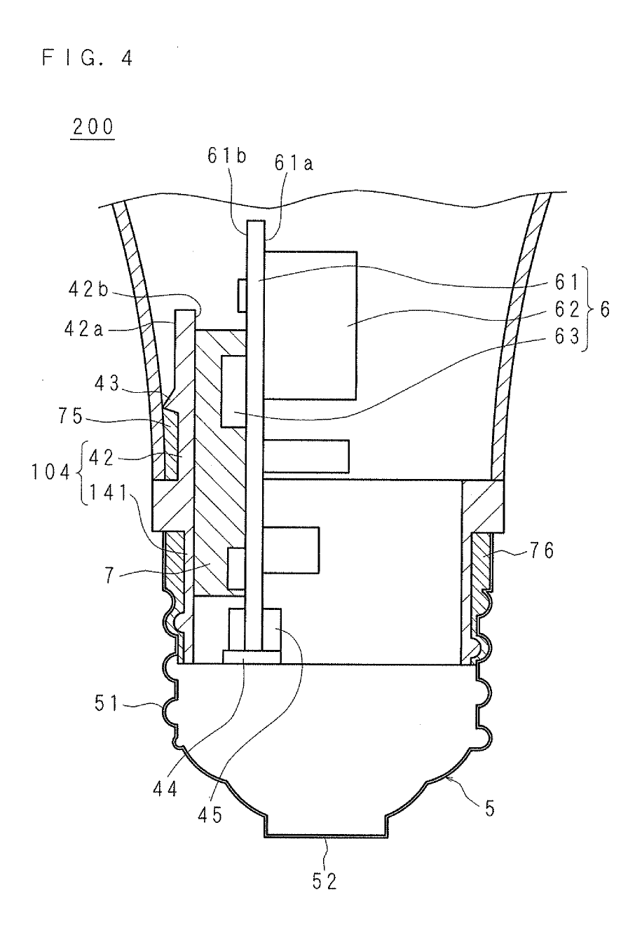

With regard to the lighting apparatus 100 related to the above embodiment, the base 5 is formed integratedly with the insulating ring 4; however, it is not limited to this case. The base 5 and the insulating ring 4 may be formed separately. FIG. 4 is a schematic vertical cross sectional view at the vicinity of a power supply circuit section 6 of a lighting apparatus 200 related to another embodiment of the present invention.

An insulating ring 104 is formed into a cylindrical shape. The insulating ring 104 includes a base holding section 141 holding a base 5 and a junction 142 provided at the base holding section 141 in a coupled manner and connected to a heat radiating section 3. The screwed processing for screwing with the base 5 is performed on the outer circumferential surface of the base holding section 141. The base 5 is integratedly formed with the insulating ring 104 by inserting the base holding section 141 of the insulating ring 104 and screwed into the base 5. An adhesive agent 76 as the adhesive layer is filled between the base holding section 141 of the insulating ring 104 and the base 5. It is preferable that the adhesive agent 76 is an adhesive agent using the base material such as silicone. Other elements identical to those described above with reference to the lighting apparatus 100 illustrated in FIG. 2 are designated with the same reference numerals and a detailed description thereof is omitted herein.

With regard to the lighting apparatus 200 of the present embodiment, since the adhesive agent 76 is filled between the base holding section 141 of the insulating ring 104 and the base 5, the gas such as air does not exist so that heat transfer resistance between the insulating ring 104 and the base 5 can be minimized. The similar effects can be achieved as in the lighting apparatus 100.

With regard to the embodiments described above, the power supply circuit 6 accommodated in the heat radiating section 3 is described as a heating body, however, in a lighting apparatus with lighting control function for adjusting the intensity and/or chromaticity of LED, a control section for lighting control can also be a heating body. In such a case, like the power supply circuit 6 described in the above embodiments, a control circuit substrate is arranged at the vicinity of the insulating ring 4, the heat generated from the control section can be efficiently conducted to the heat radiating section 3 by filling resin between the control circuit substrate and the insulating ring 4.

With regard to the embodiments described above, the resin 7 is provided between the insulating ring 4 and the power supply substrate 61. However, it may be configured without using the resin 7.

With regard to the embodiments described above, a surface-mount LED is utilized as the light source, however, other different types of LED and EL (Electro Luminescence) may also be utilized as the light source.

With regard to the embodiments described above, a light-bulb type lighting apparatus attached to a light-bulb socket is described, however, other types of lighting apparatuses may also be applicable. Furthermore, the present invention may utilize an apparatus including a heating body other than the lighting apparatus. Besides, it is needless to say that the scope of matter described in claims can be practiced by other modified modes.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1.-6. (canceled)

7. A lighting apparatus, comprising;
a light source;
a power supply circuit section supplying power to the light source;
a heat radiating section accommodating the power supply circuit section inside and radiating heat generated in the power supply circuit section;
a connecting section connected to an external power supply; and
an insulator provided between the heat radiating section and the connecting section,
wherein the insulator is a thermal conductor.

8. The lighting apparatus according to claim 7,
wherein the connecting section is formed integratedly with the insulator.

9. The lighting apparatus according to claim 7,
wherein an adhesive layer is provided between the connecting section and the insulator.

10. The lighting apparatus according to claim 7,
wherein the power supply circuit section includes a plurality of circuit components, and at least a part of the circuit components comes in contact with the insulator.

11. The lighting apparatus according to claim 7,
wherein a thermal conduction layer is provided between the power supply circuit section and the insulator.

12. The lighting apparatus according to claim 7,
wherein the insulator contains polyamide and/or liquid crystal polymer.

13. The lighting apparatus according to claim 7,
wherein the power supply circuit section includes a substrate and a plurality of circuit components mounted on both surfaces of the substrate, and
wherein the insulator includes a junction connected to the heat radiating section and a holding section holding the power supply circuit section.

14. The lighting apparatus according to claim 13,
wherein the holding section holds the substrate such that the side of the other surface of the substrate on which the circuit components with high amount of heat radiation as compared with the circuit components mounted on one surface of the substrate are mounted is at the side of the inner surface of the junction.
